(19) United States
(12) Patent Application Publication
(10) Pub. No.: US 2007/0115488 A1
(43) Pub. Date: May 24, 2007

(54) Methods and systems for multiple encodings within a code page

(75) Inventors: Jeffery A. Engelman, Mead, CO (US); Keiko Nagano, Sagamihara-shi (JP); Noriko Nagata, Yokohama-shi (JP); David E. Stone, Longmont, CO (US)

Correspondence Address: DUFT BORNSEN & FISHMAN, LLP, 1526 SPRUCE STREET, SUITE 302, BOULDER, CO, 80302, US

(73) Assignee: International Business Machines Corporation

(21) Appl. No.: 11/285,026

(22) Filed: Nov. 22, 2005

(51) Int. Cl. G06F 3/12

(52) U.S. Cl. 358/1.13; 358/1.11

(57) ABSTRACT

Methods and systems are provided for a printer controller in a printing system to provide simple, flexible translation of received code points into any of multiple encodings. A code page data structure as generally practiced in the art is enhanced to provide translation from a first encoding of a received code point into any of multiple resultant encodings. In one aspect the enhanced code page data structure may include a mapping of a received code point into any number of Unicode scalar values. In another aspect, where no Unicode code point is available, the enhanced code page may provide a second mapping through existing code page and character name data structures to identify a corresponding glyph to be imaged on the printable medium.

### BACKGROUND OF THE INVENTION

1. Field of the Invention

The invention relates to the field of printing systems, and in particular, to methods and systems for multiple encodings for code points in a code page as often applied in a printing system.

2. Statement of the Problem

Printing systems associated with data processing enterprises generally include a localized printer controller within the printing system. The printer controller controls overall operation of the printing system including, for example, host interfacing, page description language interpretation and rasterization, and lower level process control or interface features of the printing engine associated with the printing system. Host interaction may include appropriate adapters for coupling the printing system to one or more host systems utilizing one or more communication media and one or more communication protocols. Print jobs (often referred to as “raw print jobs”) are received by the printing system from one or more attached host computer systems. The raw print jobs are generally encoded in the form of a page description language such as PostScript®, HP PCL®, IBM IPDS™(“Intelligent Printer Data Stream”), etc. In addition, raw print jobs may be encoded as simple character streams (ASCII or EBCDIC) with no page description formatting associated therewith.

All present printing systems utilize some translation architecture to translate received characters into corresponding graphical representations or “glyphs” on a printed page. For example, in simple ASCII encoding, a binary value “01000001” received as data may represent a command to place a glyph or image of the letter “A” on the printed page. However, in many applications, this mapping from received binary data to corresponding glyphs may be far more complex, flexible, and rich. For example, in printing system applications in the Far East, Chinese, Japanese, and Korean character sets and corresponding glyphs are far more complex. Many more character symbols are defined such that the encoding requires at least 16 bits of binary data to identify a desired character or glyph. Still further, other printing system applications allow a user to customize the mapping of a particular received data value to particular corresponding glyphs and even to customize the glyph itself (e.g., user-defined characters loaded from a host application to a printing system such as a customized font or customized graphics such as logos).

As complexity of these various translations grew, a standardized translation architecture evolved commonly referred to as “Unicode”. Unicode specifications are well known to those of ordinary skill in the art and are generally available at www.unicode.org. In general, all Unicode “code points” are encoded as 16 bit binary values. Some ranges of the 16 bit binary values are reserved as “surrogates” that may indicate another 16 bit Unicode value follows to provide the ability to encode more than 64K code points in the 16 bit Unicode code point values.

Some printing systems directly accept Unicode encoded information to identify particular glyphs and graphics to be imaged on the printable medium of a printing system. In such systems, little or no translation is required. Received information is already encoded in the final form in which the printing system controller may utilize it to present glyphs and images to a user.

However, a much larger class of printing systems and associated printing applications remain that do not encode information to the printing system in Unicode form. Rather, data is received as a sequence of 8 or 16 bit binary data (e.g., a sequence of “code points”) which are then translated in accordance with a current “code page” into corresponding glyphs for imaging on the printable medium. This translation may be through an intermediate “character name”. For example, in the IBM Advanced Function Presentation (“AFP™”—also referred to as Advanced Function Printing) architecture, a code point is mapped through a current code page into a standardized character name. That character name is then mapped to a currently defined glyph to be imaged on the printable medium.

A problem arises in such printing systems when the printing system uses a font or symbol library that is encoded in Unicode standard encoding. For example, where a printing system that uses a code page architecture (such as IBM AFP™ printing systems) is requested to use a TrueType® font encoded in accordance with Unicode standards, the code page translation process is cumbersome if not inadequate. Similarly, user-defined characters may be defined in a printing application in accordance with Unicode standards but a legacy printing system using the code page translation architecture may encounter problems translating such a user-defined code point and character glyph.

In presently known code page architecture translation printing system (such as IBM AFP™ printing systems), user-defined code points cannot be easily translated. It is therefore a problem to provide simple and effective translation of code points in a printing system that is defined outside the standard encodings allowed by the code page architecture.

### SUMMARY OF THE SOLUTION

The invention solves the above and other related problems with methods and associated systems and apparatus operable to translate a received code point from a first encoding into any of multiple second encodings.

In one aspect here, a method is provided operable within a printer controller of a printing system. The method includes receiving a code point encoded in a first encoding. The received code point is then translated into a translated code point in accordance with any of multiple other encodings using a code page translation data structure. The translated code point is then used to present one or more corresponding glyphs on a printed page from the printing system.

Another aspect hereof provides a method operable in a printer controller of a printing system. The method includes receiving a received code point from an attached host system and identifying an identified code page data structure to be used for translation of the received code point. The method then determines whether the identified code page data structure specifies any Unicode scalar value corresponding to the received code point. In response to determining that the code page data structure specifies at least one corresponding Unicode scalar values corresponding to the received code point, the method then translates the received code point into one or more Unicode scalar values in accordance with the identified code page data structure. The method then selects one or more glyphs corresponding to the one or more Unicode scalar values and prints the one or more selected glyphs on a printed page.

Yet another aspect hereof provides a printing system that includes a marking engine for printing information on a printable medium and includes a printer controller adapted to receive a sequence of code points representing glyph images to be imprinted on the printable medium and adapted to translate each received code point from a first encoding to any of multiple second encodings. The printer controller includes a code page translation data structure including a plurality of entries such that each entry maps a corresponding code point encoded in a first encoding into any of the multiple second encodings and includes a code point translator configured to map a received code point to the any of the multiple second encodings using the code page translation data structure.

Still another aspect hereof provides a printer controller. The printer controller is adapted to receive a code point from an attached host system. The controller then includes a code page data structure having a plurality of entries each having information configured for translation of a received code point. The controller also has a code point translator coupled to the code point receiver and coupled to the code page data structure and adapted to translate a received code point into zero or more Unicode scalar values corresponding to the received code point. The controller also includes a glyph presenter coupled to the code point translator to present on a printed page one or more selected glyphs corresponding to the zero or more Unicode scalar values. The code point translator is operable in response to determining that the code page data structure specifies at least one corresponding Unicode scalar values corresponding to the received code point to translate the received code point into one or more Unicode scalar values in accordance with the identified code page data structure.

The invention may include other exemplary embodiments described below.

### DESCRIPTION OF THE DRAWINGS

The same reference number represents the same element on all drawings.

FIG. 1 is a block diagram of a printing system enhanced in accordance with features and aspects hereof to translate received code points in a first encoding into any of multiple second encodings.

FIG. 2 is a block diagram of a system in accordance with features and aspects hereof that translates received code points into any of multiple second encodings.

FIGS. 3-4 are flowcharts describing exemplary methods in accordance with features and aspects hereof to translate a received code point in a first encoding into any of multiple second encodings.

FIG. 5 is a block diagram of an exemplary data processing system that may provide printer controller features and aspects hereof including bulk storage of a program product that may embody methods and processes hereof.

### DETAILED DESCRIPTION OF THE INVENTION

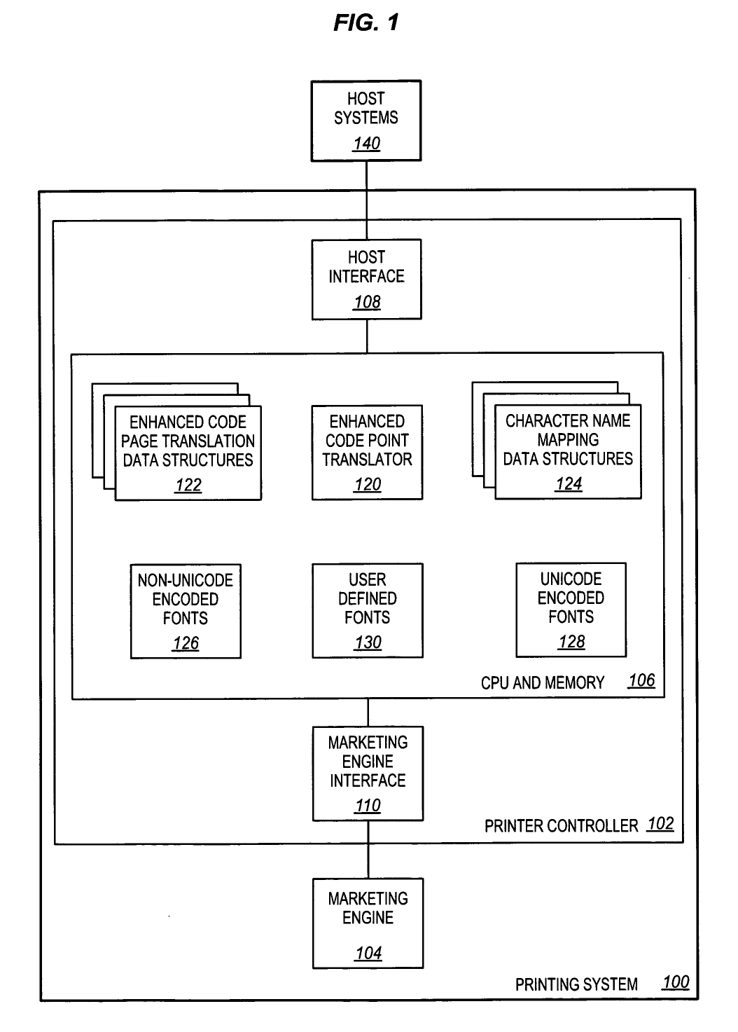

FIGS. 1-5 and the following description depict specific exemplary embodiments of the present invention to teach those skilled in the art how to make and use the invention. For the purpose of this teaching, some conventional aspects of the invention have been simplified or omitted. Those skilled in the art will appreciate variations from these embodiments that fall within the scope of the present invention. Those skilled in the art will appreciate that the features described below can be combined in various ways to form multiple variations of the present invention. As a result, the invention is not limited to the specific embodiments described below, but only by the claims and their equivalents.

FIG. 1 is a block diagram of an exemplary printing system 100 coupled to one or more host systems 140 for purposes of printing host system supplied information on a printable medium. Such a printing system 100 generally includes a printer controller 102 coupled to a marking engine 104. The marking engine 104 places ink or toner on the printable medium to form a printed image representing a sequence of received code points and commands from a host system. To perform such operations, printer controller 102 may preferably include host interface 108 for coupling the printing system 100 to one or more host systems 140 and may include marking engine interface 110 for coupling the printing printer controller 102 to marking engine 104.

As discussed above, information received from a host system may include a sequence of individual code points representing, for example, characters to be printed on the associated printed page. Each code point therefore represents some graphical representation of a character, logo, or other user-defined image corresponding to the particular code point value.

The code point values are encoded in accordance with a first encoding scheme associated with the host system or application that generates the sequence of code points transmitted to the printing system 100. However, associated font images or glyphs associated with a code point may be encoded in accordance with one or more second encodings different from the first encoding. For example, code points may be received encoded in ASCII or EBCDIC code point values but may be represented by glyphs and/or user-defined glyph images encoded in accordance with Unicode or other encoding standards. Or, for example, a user may define a single code point to correspond to a graphical combination of multiple Unicode encoded scalar values.

To process such code point translations, printer controller 102 may include functional elements within CPU and memory 106 programmed to perform desired translations of received code points into corresponding glyphs or font images. Those of ordinary skill in the art will readily recognize that the elements depicted within CPU and memory 106 may be equivalently implemented as custom designed circuits or as suitably programmed instructions operable within a general or special purpose processor to provide the depicted functionality.

Enhanced code point translator 120 may be adapted to translate received code points encoded in the first encoding into any of multiple second encodings in accordance with enhanced code page translation data structures 122. Any number of predefined enhanced code page translation data structures 122 may be provided within printer controller 102 in addition to user-defined enhanced code page translation data structures provided by a host system 140 or associated applications. For example, enhanced code point translator 120 may translate a received a code point into a standardized character name for use in identifying one or more glyphs or font images to be presented on a printed page. For example, enhanced code point translator 120 may translate a received code point into zero or more Unicode encoded scalar values representing one or more corresponding glyphs or font images.

An exemplary enhanced code page translation data structure may include exemplary fields as follows:

Code Point:

code point value as encoded in a first encoding

Character Name:

a second encoding representing a standardized character name for the corresponding code point value

Number (N) of Unicode Scalar Values:

a second encoding representing the corresponding code point as zero or more Unicode scalar values

N Unicode Scalar Values:

zero or more (N) Unicode scalar values representing glyphs for presenting the corresponding code point

Where an enhanced code point translator 120 translates a received code point into a corresponding standardized character name, character name mapping data structures 124 may be provided in CPU and memory 106 to provide a further translation of the character name as zero or more Unicode scalar values corresponding to glyphs or font character images. An exemplary character name to Unicode scalar value translation data structure entry may include exemplary fields as follows:

Character Name:

a standardized character name

Number (N) of Unicode Scalar Values:

a second encoding representing the corresponding character name as zero or more Unicode scalar values

N Unicode Scalar Values:

zero or more (N) Unicode scalar values representing glyphs for presenting the corresponding character name

Further translation features of enhanced code point translator 120 may translate a character name encoding or a Unicode encoding into corresponding font characters or glyphs in accordance with non-Unicode encoded fonts 126, Unicode encoded fonts 128, and user defined fonts 130 (often encoded as Unicode encoded fonts). The processing of enhanced code point translator 120 may eventually result in identifying one or more glyphs or font images to be presented on the printed page by the printing system 100. In some error conditions, translation of a code point may result in no particular glyph or font image being presented on the printed page depending on the requirements of the particular page description language or other control aspects of the printer system 100. Such error processing will be readily apparent to those of ordinary skill in the art.

Enhanced code point translator 120 is therefore operable to translate a received code point from a first encoding into one or more second encodings including, for example, a character name encoding and a Unicode encoding. In particular, enhanced code point translator 120 may be operable to translate a received code point into any number of Unicode scalar values to permit flexible definition of glyphs to be presented for a particular corresponding code point.

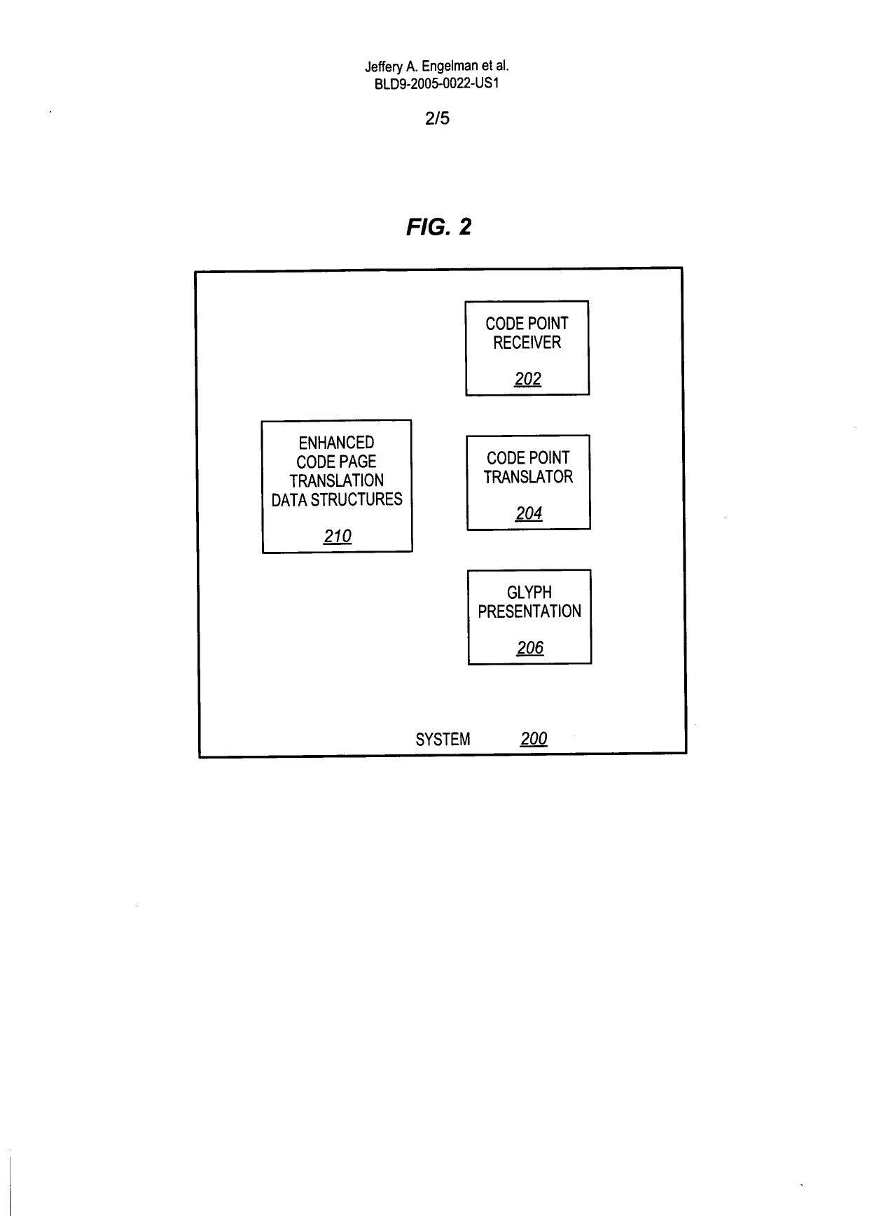

FIG. 2 represents an exemplary system 200 in the broadest aspects hereof whether within a printing system or other presentation or display systems. A code point receiver 202 is coupled to a code point translator 204 such that a received code point is translated from a first encoding into one or more second encodings. A glyph presentation element 206 is then operable to present zero or more glyphs corresponding to the translated, received code point on a presentation medium such as a printed page or an electronic display. Code point translator 204 may be operable in accordance with information contained in enhanced code page translation data structures 210. The enhanced code page translation data structures may each include multiple entries—one entry for each code point to be translated for the corresponding code page. The entry may then include any number of secondary encodings of the corresponding code point for use by code point translator 204 in conjunction with glyph presentation element 206.

Those of ordinary skill in the art will readily recognize a variety of systems in accordance with the broadest aspects of FIG. 2 in which code point translation may be performed in accordance with features and aspects hereof. Further, those of ordinary skill in the art will recognize a variety of printing systems as exemplified in FIG. 1 wherein flexible code point translation may be performed in accordance with features and aspects hereof. FIGS. 1 and 2 are therefore intended merely as exemplary systems embodying features and aspects hereof for flexible code point translation from a first received encoding into any of multiple second encodings.

Still farther, those of ordinary skill in the art will recognize a variety of additional elements within a fully operable printing system as shown in FIG. 1, for simplicity and brevity of this description; numerous such elements are left out of FIGS. 1 and 2.

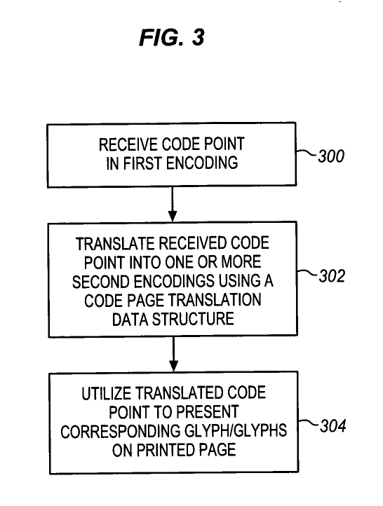

FIG. 3 is a flowchart describing an exemplary method in accordance with broad aspects hereof in which a received code point is translated from the first encoding to any of multiple second encodings using an enhanced code page translation data structure. Element 300 is first operable to receive a code point encoded in the first encoding from an attached host system or application. Element 302 is then operable to translate the received code point into one or more second encodings using an enhanced code page translation data structure. Such a translation data structure, as noted above, may contain multiple entries each identifying multiple second encodings associated with a corresponding received code point. Lastly, element 304 is operable to utilize the translated code point information to present zero or more corresponding glyphs on a printed page or other presentation medium.

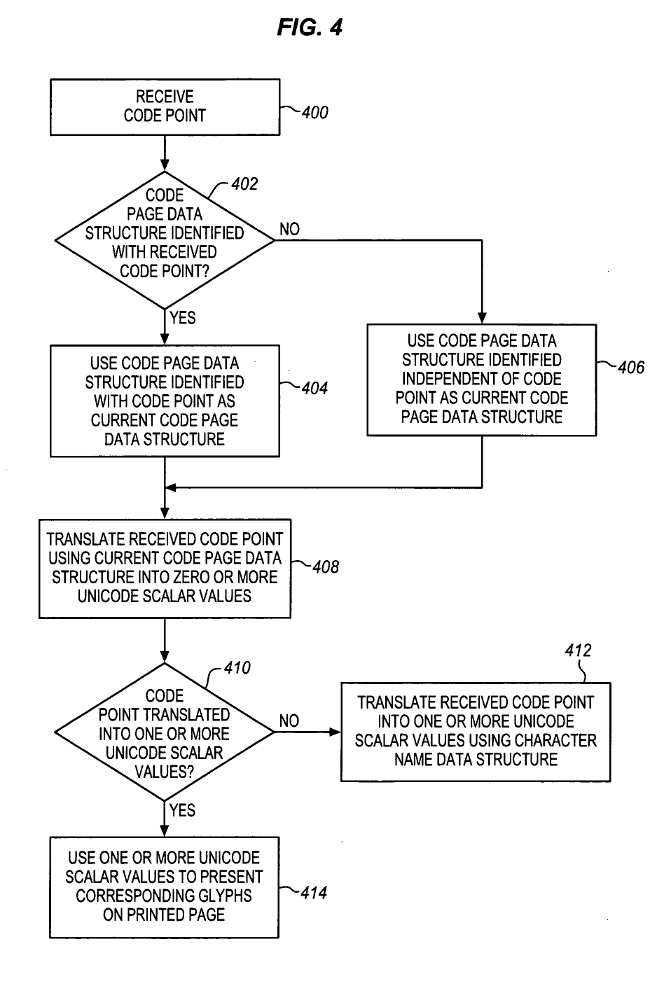

FIG. 4 is a flowchart providing additional details of an exemplary method in accordance with features and aspects hereof for translation of a received code point from a first encoding into one or more second encodings as may be useful in a printing system. Element 400 is first operable to receive a code point from an attached host system or application encoded using a first encoding such as, for example, ASCII or EBCDIC, as carried within IPDS™ commands.

Those of ordinary skill in the art will recognize a wide variety of well known techniques for specifying a code page or font data structure associated with a received code point or for selecting a predefined code page or font data structure for use over a sequence of received code points. For example, IBM's IPDS™ command and control language allows for associating a particular code page or other font data structure information with all subsequently received code points. Alternatively, IPDS™ allows for specifying a particular code page and/or font to be associated with a particular received code point as part of the transmission of that code point. Numerous other equivalent techniques are well known to those of ordinary skill in the art and associated with other command and control languages and page description languages. For example, PCL® and Postscript® have associated similar techniques for defining the encoding of a particular received code point or of a sequence of received code points for translation into corresponding glyphs for presentation on a printed page or other presentation medium.

Depending upon the particular command language or page description language in which the code point is received and encoded, a particular code page data structure or other font mapping identification may be received with the code point or may be previously designated by other commands of the command language or page description language. Element 402 then determines whether the received code point information includes additional information identifying a particular code page to be used in translating the received code point. If so, element 404 is operable to designate the identified code page received along with information associated with the code point as the current code page for purposes of subsequent translation. Processing then continues with element 408 as discussed further herein below. If element 402 determines that no particular code page is associated with the information received with the code point, element 406 is operable to use a current code page designated or identified by other commands previously received as the current code page data structure for subsequent translations.

Element 408 is then operable to translate the received code point using the current code page data structure designated by operation of either element 404 or 406. Element 408 is generally operable to translate the received code point into zero or more Unicode scalar values. As discussed above, the code page data structure is enhanced in accordance with features and aspects hereof to include multiple second encodings associated with each code point in a corresponding entry of the data structure. In particular, an exemplary code page data structure may include a second encoding in the form of a standardized character name designation associated with the corresponding code point of the entry as well as another second encoding in the form of zero or more Unicode scalar values to be associated with a corresponding code point of the entry.

Element 410 then determines whether the translation step of element 408 resulted in the translation of the received code point into one or more Unicode scalar values. If so, processing continues with element 414 as discussed further herein below. If not, in other words if the translation resulted in zero Unicode scalar values, element 412 is operable to translate the received code point into one or more scalar values by first translating the code point into a standardized character name and then applying the character name to a character name to Unicode translation data structure. As noted above, an enhanced code page data structure in accordance with features and aspects hereof may include information for translation from the first encoding of the code point into a second encoding as a standardized character name. The character name may be standardized in accordance with vendor or other industry standards for naming characters. An additional translation data structure for translating standardized character names into zero or more Unicode scalar values may be associated with the printing system or associated with a particular code page data structure for translating the standardized character name into zero or more Unicode scalar values. Processing then continues with element 414 to utilize the one or more Unicode scalar values to identify corresponding glyphs or font images to be printed on the printable medium in the printing system.

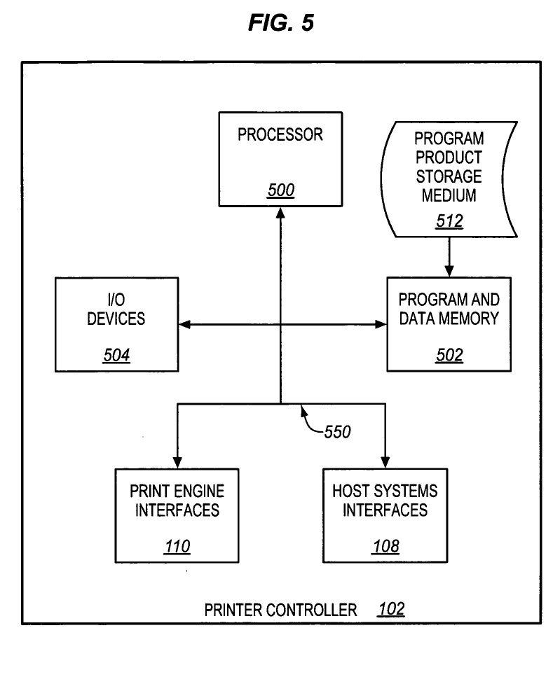

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, etc. FIG. 5 is a block diagram depicting a printer controller 102 as including a data processing device (CPU 500 and Memory 502) adapted to provide features and aspects hereof by executing programmed instructions and accessing data stored on a computer readable storage medium 512.

Furthermore, the invention can take the form of a computer program product accessible from a computer-usable or computer-readable medium 512 providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor 500 coupled directly or indirectly to memory elements 502 through a system bus 550. The memory elements can include local memory employed during actual execution of the program code, bulk storage, and cache memories which provide temporary storage of at least some program code in order to reduce the number of times code must be retrieved from bulk storage during execution.

Input/output or I/O devices 504 (including but not limited to keyboards, displays, pointing devices, etc.) can be coupled to the system either directly or through intervening I/O controllers. One particular I/O device useful in a data processing system adapted as a printer controller is a print engine interface 110 for coupling the printer controller 102 to the signals and protocols of the print engines adapted for marking pixels on paper.

Network adapters or other host system interfaces 108 may also be coupled to the system to enable the data processing system to become coupled to other data processing systems or storage devices through intervening private or public networks. Modems, cable modems, IBM Channel attachments, SCSI, Fibre Channel, and Ethernet cards are just a few of the currently available types of network or host interface adapters.

Although specific embodiments were described herein, the scope of the invention is not limited to those specific embodiments. The scope of the invention is defined by the following claims and any equivalents thereof.

We claim:

1. A method operable within a printer controller of a printing system, the method: comprising:
receiving a code point encoded in a first encoding;
translating the received code point into a translated code point in accordance with any of multiple other encodings using a code page translation data structure; and
using the translated code point to present one or more corresponding glyphs on a printed page from the printing system.

2. The method of claim 1 wherein the step of translating further comprises:
translating the received code point into a Unicode code point using the code page translation data structure.

3. The method of claim 1 wherein the step of translating further comprises:
translating the received code point into one or more Unicode scalar values.

4. The method of claim 1 wherein the step of translating further comprises:
mapping the received code point into zero or more Unicode scalar values using the code page translation data structure;
determining whether the step of mapping the received code point produced zero Unicode scalar values; and
in response to determining that the step of mapping the received code point produced zero Unicode scalar values, re-mapping the received code point into a character name using the code page translation data structure.

5. The method of claim 4 wherein the step of translating further comprises:
in response to determining that the step of mapping the received code point produced one or more Unicode scalar value, identifying one or more glyphs corresponding to the one or more Unicode scalar values for printing on the page.

6. The method of claim 4 wherein the step of translating further comprises:
determining whether the step of re-mapping produced a character name;
in response to determining that the step of re-mapping produced a character name, translating the character name into one or more Unicode scalar values using a character name translation data structure.

7. The method of claim 6 wherein the step of translating further comprises:
identifying one or more glyphs corresponding to the one or more Unicode scalar values produced by translating the character name.

8. A method operable in a printer controller of a printing system, the method comprising:
receiving a received code point from an attached host system;
identifying an identified code page data structure to be used for translation of the received code point;
determining whether the identified code page data structure specifies any Unicode scalar values corresponding to the received code point;
in response to determining that the code page data structure specifies at least one corresponding Unicode scalar values corresponding to the received code point, translating the received code point into one or more Unicode scalar values in accordance with the identified code page data structure;
selecting one or more glyphs corresponding to the one or more Unicode scalar values; and
printing the one or more selected glyphs on a printed page.

9. The method of claim 8 further comprising:
in response to determining that the code page data structure identifies no Unicode scalar values corresponding to the received code point, translating the received code point into a character name using the identified code page data structure; and
further translating the character name into one or more corresponding Unicode scalar values using a character name translation data structure.

10. The method of claim 8 further comprising:
identifying an identified code page data structure used for translating in accordance with information received with the received code point.

11. The method of claim 8 further comprising:
identifying an identified code page data structure used for translating in accordance with information independent of the received code point.

12. A printing system comprising:
a marking engine for printing information on a printable medium; and
a printer controller adapted to receive a sequence of code points representing glyph images to be imprinted on the printable medium and adapted to translate each received code point from a first encoding to any of multiple second encodings, wherein the printer controller further comprises:
a code page translation data structure including a plurality of entries wherein each entry maps a corresponding code point encoded in a first encoding into any of said multiple second encodings; and
a code point translator configured to map a received code point to said any of said multiple second encodings using said code page translation data structure.

13. The printing system of claim 12 wherein at least one of the multiple second encodings defined in the code page translation data structure translates a corresponding code point into zero or more Unicode scalar values.

14. The printing system of claim 13 wherein the at least one of the multiple second encodings translates the corresponding code point into multiple Unicode scalar values.

15. The printing system of claim 12:
wherein at least one of the multiple second encodings defined in the code page translation data structure translates a corresponding code point into a character name, and
wherein the printer controller further comprises a character name mapping data structure having a plurality of entries wherein each entry maps a corresponding character name into zero or more Unicode scalar values.

16. A printer controller comprising:
a code point receiver adapted to receive a code point from an attached host system;
a code page data structure having a plurality of entries each having information configured for translation of a received code point;
a code point translator coupled to the code point receiver and coupled to the code page data structure and adapted to translate a received code point into zero or more Unicode scalar values corresponding to the received code point; and
a glyph presenter coupled to the code point translator to present on a printed page one or more selected glyphs corresponding to the zero or more Unicode scalar values.
wherein the code point translator is operable in response to determining that the code page data structure specifies at least one corresponding Unicode scalar values corresponding to the received code point to translate the received code point into one or more Unicode scalar values in accordance with the identified code page data structure.

17. The printer controller of claim 16:
wherein the code point translator is further operable in response to determining that the code page data structure identifies no Unicode scalar values corresponding to the received code point to translate the received code point into a character name using the identified code page data structure, and
wherein the code point translator is further operable to translate the character name into one or more corresponding Unicode scalar values using a character name translation data structure.

18. The printer controller of claim 16:
wherein the code point translator is further operable to identify an identified code page data structure to use in translating in accordance with information received with the received code point.

19. The printer controller of claim 16:
wherein the code point translator is further operable to identify identified code page data structure to use in translating in accordance with information independent of the received code point.
